(19) United States
(12) Patent Application Publication
(10) Pub. No.: US 2021/0389707 A1
(43) Pub. Date: Dec. 16, 2021

(54) IMAGE FORMING APPARATUS, PRESSING FORCE CONTROL METHOD, AND PRESSING FORCE CONTROL PROGRAM

(71) Applicant: Konica Minolta, Inc., Tokyo (JP)

(72) Inventor: Hideki HADANO, Toyokawa-shi (JP)

(21) Appl. No.: 17/340,441

(22) Filed: Jun. 7, 2021

(30) Foreign Application Priority Data
Jun. 10, 2020 (JP) 2020-101135

(51) Int. Cl. G03G 15/20

(52) U.S. Cl. CPC G03G 15/2053

(57) ABSTRACT

An image forming apparatus includes: a pressure roller; a heater that faces the pressure roller and forms a nip part with the pressure roller, the nip part being between the pressure roller and the heater; and a hardware processor that adjusts a pressing force for pressing either the pressure roller or the heater toward the other and determines the pressing force based on a size of a recording medium that passes through the nip part.

The entire disclosure of Japanese patent Application No. 2020-101135, filed on Jun. 10, 2020, is incorporated herein by reference in its entirety.

### BACKGROUND

### Technological Field

The present invention relates to an image forming apparatus, a pressing force control method, and a pressing force control program, and particularly to an image forming apparatus that fixes toner on a recording medium by pressing and heating the recording medium, a pressing force control method that is executed on the image forming apparatus, and a pressing force control program that causes a computer that controls the image forming apparatus to execute the pressing force control method.

### Description of the Related Art

Image forming apparatuses such as copiers, printers, and facsimiles are provided with a fixing device that presses and heats paper with a toner-based image formed thereon to fix the toner on the paper. For example, JP 2014-178633 A describes a fixing device including: an endless fixing member having flexibility; a heating source that heats the fixing member; a pressure member that forms a nip with the fixing member; a nip forming member that faces the pressure member inside the fixing member and forms the nip; a support member that supports the nip forming member; a pair of holding members that hold the two axial ends of the fixing member; a rotation drive means that rotates the pressure member; and a torque measurement means that measures the torque with which the rotation drive means rotates the pressing means, where the rotation frequency of the rotation drive means is controlled from torque information obtained through measurement by the torque measurement means.

The fixing device described in JP 2014-178633 A detects a phenomenon in which the torque drops sharply in a spinning state that emerges as a result of the transition of the friction between the fixing member and the pressure member from static friction to dynamic friction, and controls the rotation frequency so as to prevent spinning.

However, when the fixing member and the pressure member slip, the paper in contact with the fixing member and the pressure member also slips, which is problematic because the toner formed on the paper is rubbed and the image quality is deteriorated. Therefore, it is preferable to prevent the fixing member and the pressure member from slipping.

### SUMMARY

An object of the present invention is to provide an image forming apparatus that prevents deterioration of image quality due to slipping of a recording medium.

Another object of the present invention is to provide a pressing force control method for preventing deterioration of image quality due to slipping of a recording medium.

Still another object of the present invention is to provide a pressing force control program for preventing deterioration of image quality due to slipping of a recording medium.

To achieve at least one of the abovementioned objects, according to an aspect of the present invention, an image forming apparatus reflecting one aspect of the present invention comprises: a pressure roller; a heater that faces the pressure roller and forms a nip part with the pressure roller, the nip part being between the pressure roller and the heater; and a hardware processor that adjusts a pressing force for pressing either the pressure roller or the heater toward the other and determines the pressing force based on a size of a recording medium that passes through the nip part.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a first perspective view illustrating the appearance of a printer according to an embodiment of the present invention;

FIG. 2 is a block diagram illustrating an example of the hardware configuration of the printer;

FIG. 3 is a cross-sectional view schematically illustrating an example of the internal configuration of the printer;

FIG. 4 is a cross-sectional view of a fixing device;

FIG. 5 is a first diagram for explaining a change in the area of contact between a fixing belt and a pressure roller;

FIG. 6 is a second diagram for explaining a change in the area of contact between the fixing belt and the pressure roller;

FIG. 7 is a first view illustrating a pressing force adjusting mechanism;

FIG. 8 is a second view illustrating the pressing force adjusting mechanism;

FIG. 9 is a diagram illustrating an example of the relationship between the cumulative number of drives and the load of the fixing belt;

FIG. 10 is a diagram illustrating an example of the relationship between the torque for rotating the pressure roller and the pressing force;

FIG. 11 is a block diagram illustrating an example of the functions of a CPU provided in the printer according to the present embodiment; and

FIG. 12 is a flowchart illustrating an example of the procedure for pressing force control processing.

### DETAILED DESCRIPTION OF EMBODIMENTS

Hereinafter, one or more embodiments of the present invention will be described with reference to the drawings. However, the scope of the invention is not limited to the disclosed embodiments. In the following description, identical parts are denoted by the same reference signs. Their names and functions are also the same. Therefore, the detailed description thereof is not repeated.

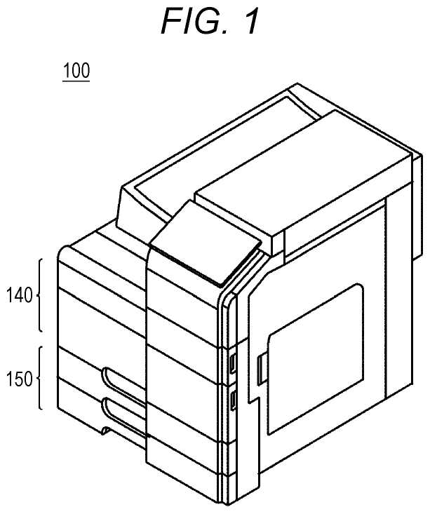

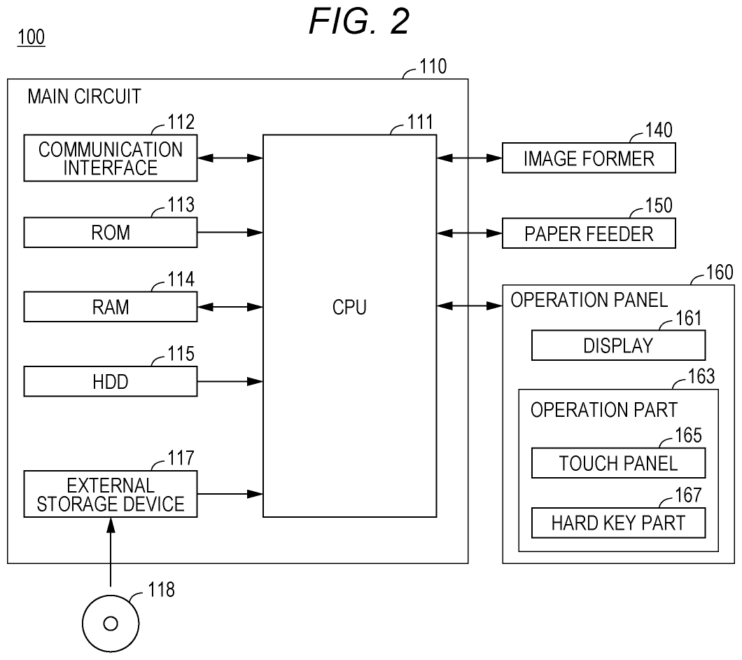

FIG. 1 is a first perspective view illustrating the appearance of a printer according to an embodiment of the present invention. FIG. 2 is a block diagram illustrating an example of the hardware configuration of the printer. Referring to FIGS. 1 and 2, the printer 100 is an example of an image forming apparatus, which includes a main circuit 110, an image former 140 for forming an image on paper or the like based on image data, a paper feeder 150 for supplying paper to the image former 140, and an operation panel 160 as a user interface.

The main circuit 110 includes a central processing unit (CPU) 111 that controls the entire printer 100, a communication interface 112, a read only memory (ROM) 113, a random access memory (RAM) 114, a hard disk drive (HDD) 115 as a large-capacity storage device, and an external storage device 117. The CPU 111 is connected to the image former 140, the paper feeder 150, and the operation panel 160, and controls the entire printer 100.

The paper feeder 150 conveys the paper contained in a paper feed cassette to the image former 140. The image former 140 is controlled by the CPU 111 to form an image using a well-known electrophotographic method. The image former 140 forms an image on the paper conveyed by the paper feeder 150 based on the image data input from the CPU 111, and discharges the paper with the image formed thereon to a paper ejection tray 39. The image data output by the CPU 111 to the image former 140 include image data such as print data received from an external personal computer or the like.

The ROM 113 stores programs that are executed by the CPU 111 or data required for the execution of the programs. The RAM 114 is used as a work area when the CPU 111 executes programs.

The operation panel 160 is provided on the upper surface of the printer 100. The operation panel 160 includes a display 161 and an operation part 163. The display 161 is a liquid crystal display (LCD), for example, and displays an instruction menu for the user, information on acquired image data, and the like. Note that the display 161 can be any device that displays images and, for example, an organic electroluminescence (EL) display can be used instead of the LCD.

The operation part 163 includes a touch panel 165 and a hard key part 167. The hard key part 167 includes a plurality of hard keys. The hard keys are, for example, contact switches. The touch panel 165 detects the position specified by the user on the display surface of the display 161.

The communication interface 112 is an interface for connecting the printer 100 to a network. The communication interface 112 communicates with other computers connected to the network using a communication protocol such as the Transmission Control Protocol (TCP) or the User Datagram Protocol (UDP). Note that the network to which the communication interface 112 is connected is a local area network (LAN), and the connection form may be either wired or wireless. Instead of the LAN, the network may be a wide area network (WAN), a public switched telephone network (PSTN), the Internet, or the like.

The external storage device 117 is controlled by the CPU 111, and a compact disk read only memory (CD-ROM) 118 or a semiconductor memory is loaded therein.

The present embodiment describes an example in which the CPU 111 executes a program stored in the ROM 113. However, the CPU 111 may control the external storage device 117 to read a program from the CD-ROM 118 for execution by the CPU 111, store the read program in the RAM 114, and execute the program.

Note that the recording medium for storing programs for execution by the CPU 111 is not limited to the CD-ROM 118, and may be a medium such as a flexible disk, a cassette tape, an optical disc (magnetic optical disc (MO), mini disc (MD), or digital versatile disc (DVD)), or a semiconductor memory such as an IC card, an optical card, a mask ROM, or an erasable programmable ROM (EPROM). Furthermore, the CPU 111 may download a program from a computer connected to the network and store the program in the HDD 115, or a computer connected to the network may write a program to the HDD 115, so that the program stored in the HDD 115 can be loaded to the RAM 114 and executed by the CPU 111. Programs as used herein include not only programs that can be directly executed by the CPU 111 but also source programs, compressed programs, encrypted programs, and the like.

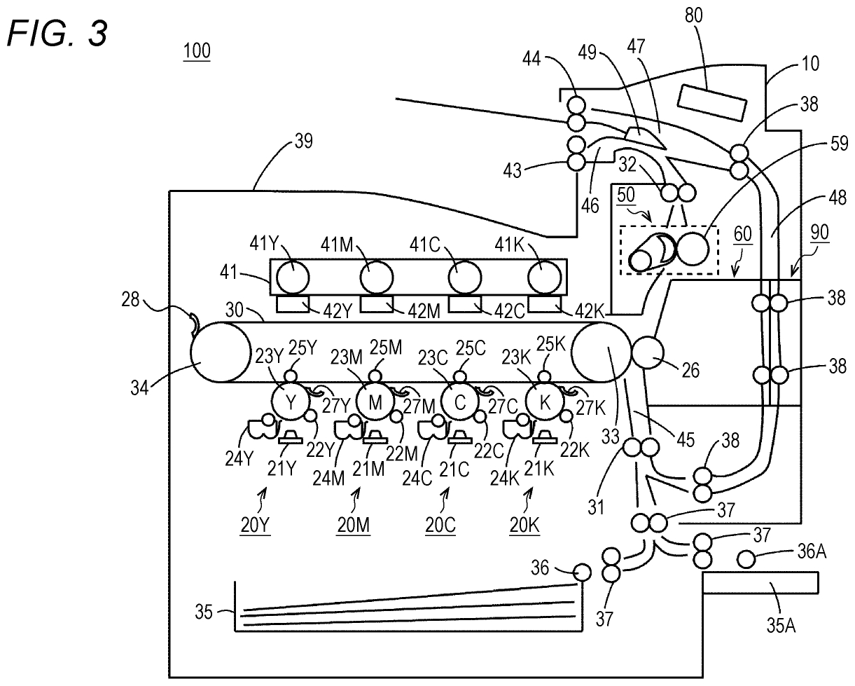

FIG. 3 is a cross-sectional view schematically illustrating an example of the internal configuration of the printer. Hereinafter, for the sake of explanation, the direction of left and right in FIG. 3 is referred to as the left-right direction, and the direction of front and back is referred to as the depth direction. The direction from left to right in the left-right direction is referred to as the right side direction, and the direction from right to left is referred to as the left side direction. The direction from front to back in the depth direction is referred to as the front direction, and the direction from back to front is referred to as the back direction.

The printer 100 includes image forming units 20Y, 20M, 20C, and 20K of yellow, magenta, cyan, and black, respectively. Here, “Y”, “M”, “C”, and “K” represent yellow, magenta, cyan, and black, respectively. At least one of the image forming units 20Y, 20M, 20C, and 20K is driven, whereby an image is formed. When all of the image forming units 20Y, 20M, 20C, and 20K are driven, a full-color image is formed. The image forming units 20Y, 20M, 20C, and 20K receive input of yellow, magenta, cyan, and black printing data, respectively. Because the image forming units 20Y, 20M, 20C, and 20K differ only in the color of the toner handled, the image forming unit 20Y for forming a yellow image will be described here.

The image forming unit 20Y includes an exposure device 21Y to which yellow printing data are input, a photoconductor drum 23Y which is an image carrier, a charge roller 22Y for uniformly charging the surface of the photoconductor drum 23Y, a developer 24Y, a primary transfer roller 25Y for transferring the toner image formed on the photoconductor drum 23Y by the action of electric field force onto an intermediate transfer belt 30 which is an image carrier, a drum cleaning blade 27Y for removing transfer residual toner from the photoconductor drum 23Y, a toner bottle 41Y, and a toner hopper 42Y.

The toner bottle 41Y contains yellow toner. The toner bottle 41Y rotates using the toner bottle motor as a drive source, and discharges toner to the outside. The toner discharged from the toner bottle 41Y is supplied to the toner hopper 42Y. The toner hopper 42Y supplies toner to the developer 24Y in response to the remaining amount of toner contained in the developer 24Y becoming equal to or less than a predetermined lower limit value.

The charge roller 22Y, the exposure device 21Y, the developer 24Y, the primary transfer roller 25Y, and the drum cleaning blade 27Y are arranged in order around the photoconductor drum 23Y along the rotation direction of the photoconductor drum 23Y.

The photoconductor drum 23Y is charged by the charge roller 22Y, and then irradiated with the laser light emitted by the exposure device 21Y. The exposure device 21Y exposes the image-corresponding portion of the surface of the photoconductor drum 23Y to form an electrostatic latent image. As a result, the electrostatic latent image is formed on the photoconductor drum 23Y. Next, the developer 24Y develops the electrostatic latent image formed on the photoconductor drum 23Y with the charged toner. Specifically, the toner is placed by the action of electric field force on the electrostatic latent image formed on the photoconductor drum 23Y, whereby the toner image is formed on the photoconductor drum 23Y. The toner image formed on the photoconductor drum 23Y is transferred with the primary transfer roller 25Y by the action of electric field force onto the intermediate transfer belt 30, which is an image carrier. The residual toner on the photoconductor drum 23Y that has not been transferred is removed from the photoconductor drum 23Y by the drum cleaning blade 27Y.

The intermediate transfer belt 30 is stretched between a drive roller 33 and a driven roller 34 so as not to loosen. In response to the drive roller 33 rotating counterclockwise in FIG. 2, the intermediate transfer belt 30 rotates counterclockwise in the figure at a predetermined speed. As the intermediate transfer belt 30 rotates, the driven roller 34 rotates counterclockwise.

As a result, the image forming units 20Y, 20M, 20C, and 20K sequentially transfer the toner images onto the intermediate transfer belt 30. The timing at which each of the image forming units 20Y, 20M, 20C, and 20K transfers the toner image onto the intermediate transfer belt 30 is adjusted by detecting a reference mark attached to the intermediate transfer belt 30. As a result, the yellow, magenta, cyan, and black toner images are superimposed on the intermediate transfer belt 30.

The toner images formed on the intermediate transfer belt 30 are transferred by the action of electric field force to the paper with a secondary transfer roller 26, which is a transfer member. The paper conveyed by a timing roller 31 is conveyed to the nip part where the intermediate transfer belt 30 and the secondary transfer roller 26 are in contact with each other. The paper with the toner images transferred thereon is conveyed to a fixing device 50, where the paper is heated and pressed. As a result, the toner is melted and fixed on the paper. After that, the paper is discharged to the paper ejection tray 39.

A belt cleaning blade 28 is provided on the intermediate transfer belt 30 upstream of the image forming unit 20Y. The belt cleaning blade 28 removes the residual toner on the intermediate transfer belt 30 that has not been transferred to the paper.

The printer 100 drives all of the image forming units 20Y, 20M, 20C, and 20K when forming a full-color image, but drives any one of the image forming units 20Y, 20M, 20C, and 20K when forming a monochrome image. It is also possible to form an image by combining two or more of the image forming units 20Y, 20M, 20C, and 20K. In the following example, tandem electrophotographic is adopted, in which the printer 100 includes the image forming units 20Y, 20M, 20C, and 20K for forming the toners of four colors on paper. Alternatively, 4-cycle electrophotographic may be adopted, in which the toners of four colors are sequentially transferred to paper with one photoconductor drum.

Multiple sheets of paper are set in the paper feed cassette 35. The paper contained in the paper feed cassette 35 is supplied to the conveyance path one by one by a take-out roller 36 attached to the paper feed cassette 35, and sent to the timing roller 31 by a paper feed roller 37. Alternatively, one or more sheets of paper may be set in a manual feed cassette 35A, in which case the one or more sheets of paper set in the manual feed cassette 35A are supplied to the conveyance path one by one by a take-out roller 36A attached to the manual feed cassette 35A, and sent to the timing roller 31 by the paper feed roller 37.

The conveyance path for paper includes an image forming path 45, a first conveyance path 46, a second conveyance path 47, and a front-back reversal path 48. The image forming path 45 is the path from the timing roller 31 to a path switching gate 49, on which the secondary transfer roller 26 and the fixing device 50 are arranged in order from the timing roller 31. The timing roller 31 feeds the paper conveyed from the paper feed cassette 35 or the manual feed cassette 35A to the image forming path 45. The timing roller 31 starts conveying the paper such that the paper reaches the secondary transfer roller 26 at the timing when the toner images formed on the intermediate transfer belt 30 reach the secondary transfer roller 26. The paper conveyed by the timing roller 31 is pushed against the intermediate transfer belt 30 by the secondary transfer roller 26, and the yellow, magenta, cyan, and black toner images superimposed on the intermediate transfer belt 30 are transferred to the paper.

The paper conveyed from the secondary transfer roller 26 is conveyed to the fixing device 50. The fixing device 50 heats and presses the paper. As a result, the toner is fixed on the paper. After that, the paper is conveyed to either the first conveyance path 46 or the second conveyance path 47 by the path switching gate 49.

The first conveyance path 46 is the path from the path switching gate 49 to a paper ejection roller 43. The paper conveyed to the first conveyance path 46 is ejected to the paper ejection tray 39 by the paper ejection roller 43.

The second conveyance path 47 is the path from the path switching gate 49 to a reversal roller 44. The second conveyance path 47 is connected to the image forming path 45 and the front-back reversal path 48 at the path switching gate 49. The paper entering the second conveyance path 47 through the path switching gate 49 is conveyed to the reversal roller 44. The reversal roller 44 performs three operations: standby, reversal, and paper ejection. In the case of standby, the reversal roller 44 rotates in the forward direction and stops after a lapse of a predetermined time from the driving of the timing roller 31. As a result, the reversal roller 44 holds the paper entering through the path switching gate 49 with its rear end out of the path switching gate 49. The reversal roller 44 performs reversal after standby. In the case of reversal, the reversal roller 44 rotates in the reverse direction and conveys the held paper toward the path switching gate 49. As a result, the paper is conveyed through the second conveyance path 47 by the reversal roller 44, and is guided to the front-back reversal path 48 by the path switching gate 49. In the case of paper ejection, the reversal roller 44 rotates in the forward direction and ejects the paper to the paper ejection tray 39.

The front-back reversal path 48 is the path connecting the path switching gate 49 and the timing roller 31 on the image forming path 45. The paper entering the front-back reversal path 48 through the path switching gate 49 is conveyed to the timing roller 31 by a conveyance roller 38. Therefore, an image is formed on the front surface of the paper while the paper first passes through the image forming path 45, and another image is formed on the back surface of the paper while the paper passes through the image forming path 45 again via the front-back reversal path 48. The paper with the image formed on its back surface is guided to the first conveyance path 46 by the path switching gate 49, and ejected to the paper ejection tray 39.

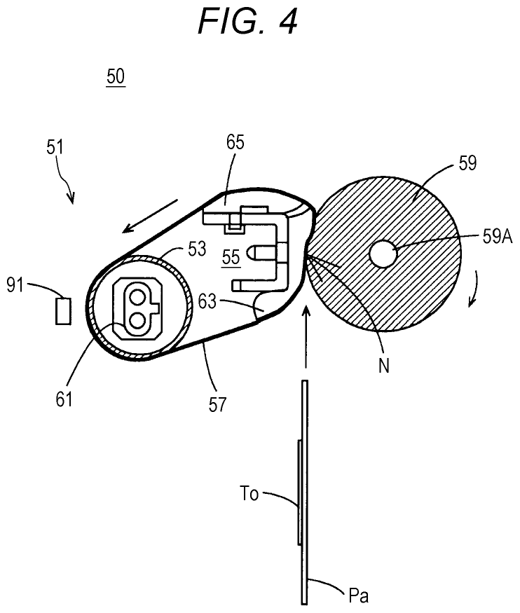

FIG. 4 is a cross-sectional view of the fixing device. FIG. 4 depicts a cross-section of the fixing device 50 taken along a plane whose normal is the rotation shaft of a pressure roller 59. Referring to FIG. 4, the fixing device 50 includes a heater 51 and the pressure roller 59. The heater 51 faces the pressure roller 59, and forms a nip part N with the pressure roller 59, the nip part N being between the pressure roller 59 and the heater 51. The nip part N is where the heater 51 and the pressure roller 59 are in contact with each other. The pressure roller 59 is pressed against the heater 51 with a predetermined pressing force.

Paper Pa carrying a toner image To on its surface is conveyed from the lower side to the upper side of the fixing device 50, and the paper Pa passes through the nip part N. While the paper Pa is passing through the nip part N, the paper Pa is heated and pressed by the pressure roller 59 and the heater 51, and the toner image To is fixed on the paper Pa.

The pressure roller 59 is composed of a core metal, an intermediate layer, and a surface layer. In the present embodiment, the outer diameter of the pressure roller 59 is 30 mm. The core metal is made of aluminum or iron, and the thickness of the core metal is 2 to 3 mm. The intermediate layer is an elastic layer that is formed of a heat-resistant elastic material such as silicone rubber or silicone sponge. The thickness of the intermediate layer is preferably about 2 to 5 mm. The surface layer is formed of a material having releasability such as a fluorine tube, and the thickness of the surface releasable layer is preferably about 20 to 80 μm.

The heater 51 includes a heating roller 53, a presser 55, an endless fixing belt 57, and a thermistor 91. The fixing belt 57 is an endless belt having flexibility. The fixing belt 57 is stretched between the heating roller 53 and the presser 55 so as not to loosen. The fixing belt 57 is composed of a base layer, an elastic layer, and a surface layer. The base layer is composed of a polyimide film having an inner diameter of 40 mm, a width of 340 mm, and a thickness of 70 μm. The elastic layer is made of silicone rubber and preferably has a thickness of about 100 to 150 μm. The surface layer is formed of a fluorine-coated release layer having a thickness of about 30 μm.

The heating roller 53 rotates due to the rotation of the fixing belt 57. Note that the heating roller 53 does not need to rotate; instead, the fixing belt 57 may slide on the surface of the heating roller 53.

The presser 55 has a fixing pad 63 and a grease applicator 65. The portion of the fixing pad 63 corresponding to the nip part N has a shape approximating to the curvature of the pressure roller 59. This ensures that the nip part N has the largest possible area while reducing the amount of elastic deformation of the pressure roller 59. The nip part N with a large area contributes to increasing the time for pressing and heating the paper. In addition, the pressure roller having an outer diameter of a predetermined value or less contributes to reducing the size of the fixing device 50. Moreover, the reduced amount of elastic deformation of the pressure roller 59 contributes to reducing the pressing force for pressing the pressure roller 59. Therefore, the pressure roller 59 only needs to have a strength of a predetermined value or less, which contributes to reducing the thickness and heat capacity of the pressure roller 59. Further, the reduced heat capacity of the pressure roller 59 leads to a decrease in power consumption.

A sliding sheet is fixed to the side of the fixing pad 63 adjacent to the nip part N in order to improve the slidability of the surface of the fixing pad 63. The sliding sheet is made of a heat-resistant glass cloth coated with fluororesin, and has heat resistance, abrasion resistance, and slidability. The fixing belt 57 is in contact with the sliding sheet. This contributes to reducing the degree of wear of the fixing belt 57 due to friction as much as possible.

The grease applicator 65 stores grease, and applies grease to the fixing belt 57 at the contact with the fixing belt 57. While the fixing belt 57 is passing through the grease applicator 65, grease is applied to the inner surface of the fixing belt 57 by friction between the fixing belt 57 and the grease applicator 65. As a result, the frictional resistance that the fixing belt 57 receives from the fixing pad 63 is reduced, and accordingly the load associated with the rotation of the fixing belt 57 around the heating roller 53 and the presser 55 is reduced.

The heating roller 53 is a hollow cylindrical member that has a heat source 61 inside. The inner diameter of the heating roller 53 is sized not to allow contact with the heat source 61. The heating roller 53 is made of stainless steel. Because the heating roller 53 is made of stainless steel, it is strong and has good workability. In this case, the thickness of the heating roller 53 can be about 0.1 mm to 0.2 mm. Note that the heating roller 53 may be made of aluminum. In this case, the thickness of the heating roller 53 is preferably 0.25 mm or more in order to secure strength against bending and local deformation. Alternatively, the heating roller 53 may be made of an iron-based metal such as a carbon steel tube for machine structural purposes (STKM).

The heat source 61 is, for example, a halogen heater. In the present embodiment, two halogen heaters having different emission lengths are used as the heat source 61. Instead of halogen heaters, a resistance heating element or induction heating (IH) may be used for the heat source 61.

The heat source 61 generates heat, whereby the heating roller 53 is heated and the temperature of the heating roller 53 rises. The temperature of the heating roller 53 is detected by the thermistor 91. The heat source 61 is controlled to be turned on/off according to the temperature detected by the thermistor 91, so that the heating roller 53 is controlled to have a predetermined temperature. The heating roller 53 has reduced thickness and accordingly has reduced heat capacity. Therefore, the heating roller 53 has a high rate of temperature increase, which contributes to reducing the warm-up time required for the heating roller 53 to reach a predetermined temperature. This also contributes to reducing the electric power consumption of the heat source 61.

The fixing belt 57 is heated to a predetermined temperature by the heat transmitted from the heating roller 53 while in contact with the heating roller 53.

The pressure roller 59 is rotated by a drive motor 59B. The rotation of the pressure roller 59 causes the fixing belt 57 to rotate. The fixing belt 57 is heated by the heating roller 53 while being rotated. The paper Pa carrying the toner image To is controlled to enter the nip part N after the fixing belt 57 is heated to a predetermined temperature. The toner image To is fixed on the paper Pa by heat and pressure while the paper Pa is passing through the nip part N.

Although the present embodiment shows an example in which the heat of the heating roller 53 is transmitted by conduction to heat the fixing belt 57, the fixing belt 57 may be heated using radiant heat emitted from the heating roller 53. In this case, the fixing belt 57 and the heating roller 53 do not need to be in contact with each other. Therefore, the fixing belt 57 does not need to be stretched between the heating roller 53 and the presser 55. Specifically, the fixing belt 57 is pressed between the presser 55 and the pressure roller 59, and is supported by the presser 55 and the pressure roller 59. In addition, the fixing belt 57 slides with respect to the fixing pad 63 as the pressure roller 59 rotates. As a result, the fixing belt 57 rotates around the presser 55 and the heating roller 53.

The heating roller 53 may be placed outside the fixing belt 57. In this case, the fixing belt 57 rotates around the presser 55. The heating roller 53 need not have a cylindrical shape, and an induction heating device or a ceramic heater that functions as a heat source can be used.

The frictional force between the fixing belt 57 and the pressure roller 59 has a predetermined relationship with the area of contact between the fixing belt 57 and the pressure roller 59 and the pressing force with which the pressure roller 59 presses the fixing belt 57. The larger the area, the larger the frictional force, and the larger the pressing force, the larger the frictional force. The area of contact between the fixing belt 57 and the pressure roller 59 becomes smaller when paper passes through the nip part N. Therefore, the fixing device 50 according to the present embodiment adjusts the pressing force with which the pressure roller 59 presses the fixing belt 57 according to the size of paper. Specifically, depending on the size of the paper that passes through the nip part N, the area of contact between the fixing belt 57 and the pressure roller 59 varies: the area of contact decreases as the size of paper increases. Therefore, adjustment is performed such that the larger the size of paper, the larger the pressing force with which the pressure roller 59 presses the fixing belt 57.

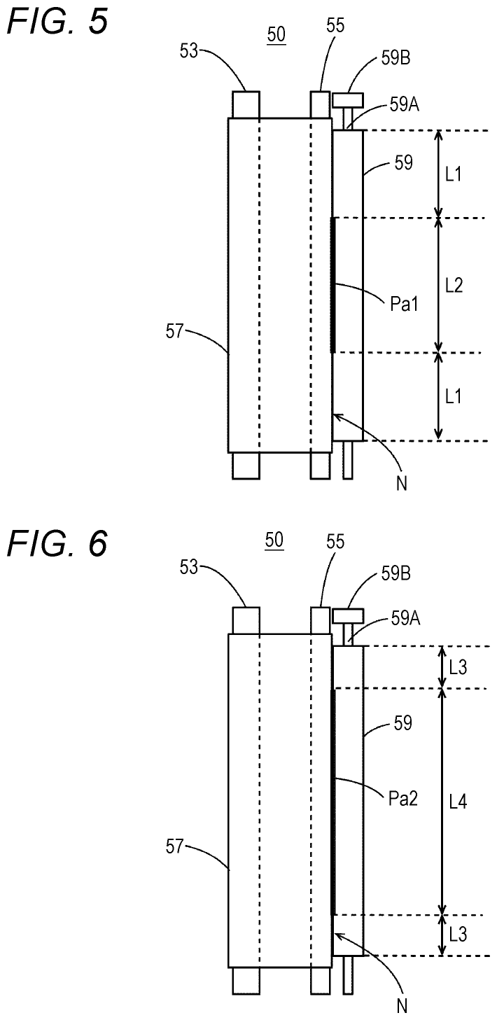

FIG. 5 is a first diagram for explaining a change in the area of contact between the fixing belt 57 and the pressure roller 59. FIG. 6 is a second diagram for explaining a change in the area of contact between the fixing belt 57 and the pressure roller 59. Hereinafter, the length, in the direction parallel to the rotation shaft of the pressure roller 59, of the paper that passes through the fixing device 50 is referred to as the size of paper. The size of paper is determined by paper type and paper orientation. Paper type indicates the type of paper such as A3, B4, or A4. Paper orientation indicates the direction in which the paper is conveyed. The direction in which the paper is conveyed can be “portrait”, in which the conveyance direction of the paper and the longitudinal direction of the paper are parallel, or “landscape”, in which the conveyance direction of the paper and the lateral direction of the paper are parallel. Hereinafter, the size of paper is indicated by a combination of paper type and paper orientation. For example, when paper type is A3 and paper orientation is portrait, the size of paper is indicated by A3 portrait. When paper type is B4 and paper orientation is portrait, the size of paper is indicated by B4 portrait. When paper type is A4 and paper orientation is portrait, the size of paper is indicated by A4 portrait. The size of paper decreases in the order of A3 portrait>B4 portrait>A4 portrait.

FIG. 5 shows an example in which paper Pa1 of type A4 is conveyed in the portrait paper orientation. The size of the paper Pa1 is L2. FIG. 6 shows an example in which paper Pa2 of type A3 is conveyed in the portrait paper orientation. The size of the paper Pa2 is L4.

Referring to FIGS. 5 and 6, the pressure roller 59 is connected at its rotation shaft to the drive motor 59B, and rotates as the drive motor 59B is driven. The rotation of the pressure roller 59 causes the fixing belt 57 to rotate, and also causes the paper Pa1 and the paper Pa2 sent to the nip part N to be conveyed. While the fixing belt 57 is rotating, heat is supplied thereto from the heating roller 53, and the circumferential surface of the fixing belt 57 is uniformly heated.

Here, the region of the nip part N that has contact with the paper Pa1 and the paper Pa2 is referred to as the paper-passing region, and the regions of the nip part N that allow direct contact between the fixing belt 57 and the pressure roller 59 without having contact with the paper Pa1 and the paper Pa2 are referred to as the contact regions.

The total length of the contact regions is 2×L1 when the paper Pa1 passes through the fixing device 50, and the total length of the contact regions is 2×L3 when the paper Pa2 passes through the fixing device 50. Here, L1>L2 is satisfied.

The rotational force from the pressure roller 59 to the fixing belt 57 is directly transmitted from the pressure roller 59 to the fixing belt 57 in the contact regions, and is transmitted through the paper in the paper-passing region. If the paper Pa1 and the paper Pa2 rub against the fixing belt 57, the toner image To carried on the paper Pa1 and the paper Pa2 is rubbed, and the image quality is deteriorated accordingly. Therefore, it is necessary to prevent the pressure roller 59 and the fixing belt 57 from slipping. In the fixing device 50, the contact regions associated with the passing of the paper Pa1 are larger than the contact regions associated with the passing of the paper Pa2. Therefore, depending on the size of the paper that passes through the fixing device 50, different levels of rotational force are transmitted from the pressure roller 59 to the fixing belt 57. Specifically, assuming that the pressing force with which the pressure roller 59 presses the heater 51 is constant, the longer the length of the paper in the direction across the fixing device 50, the smaller the rotational force transmitted from the pressure roller 59 to the fixing belt 57.

The printer 100 according to the present embodiment includes a pressing force adjusting mechanism for adjusting the pressing force with which the pressure roller 59 presses the heater 51.

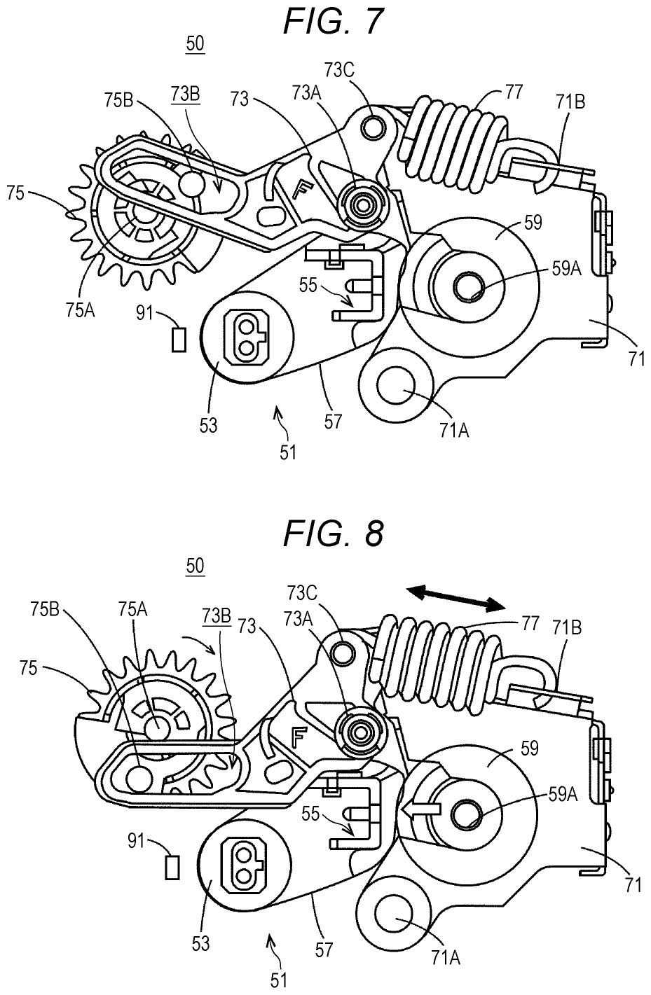

FIGS. 7 and 8 are views illustrating the pressing force adjusting mechanism Referring to FIGS. 7 and 8, the fixing device 50 includes a pressure frame 71, a lever member 73, a variable load gear 75, and a spring 77. The presser 55 is fixedly supported at both ends by the main body frame.

The pressure frame 71 is rotatably supported around a pressure frame rotation shaft 71A. The pressure frame rotation shaft 71A is fixedly supported by the main body frame. The pressure frame 71 pivotally supports the rotation shaft 59A of the pressure roller 59. Therefore, the rotation shaft 59A of the pressure roller 59 can rotate about the pressure frame rotation shaft 71A. In addition, the pressure frame 71 has a first connection 71B connected to one end of the spring 77.

The lever member 73 is rotatably supported around a lever member rotation shaft 73A. The lever member rotation shaft 73A is fixedly supported by the main body frame. In addition, the lever member 73 has a second connection 73 C connected to the other end of the spring 77. The spring 77 is energized in a direction that shortens the distance between the first connection 71B and the second connection 73C. Therefore, the pressure frame 71 is energized by the spring 77 in the counterclockwise direction about the pressure frame rotation shaft 71A, and the lever member 73 is energized by the spring 77 in the clockwise direction about the lever member rotation shaft 73A. Thus, the pressure roller 59 is pressed in the direction toward the heater 51.

The variable load gear 75 has a gear rotation shaft 75A pivotally supported by the main body frame and an adjusting rod 75B that is parallel to the gear rotation shaft 75A. The variable load gear 75 is rotated by a drive motor and rotates about the gear rotation shaft 75A.

The lever member 73 has an adjusting hole 73B through which the adjusting rod 75B of the variable load gear 75 passes. In response to the variable load gear 75 rotating clockwise, the adjusting rod 75B abuts on the side surface of the adjusting hole 73B and then slides. As a result, the lever member 73 rotates about the lever member rotation shaft 73A. As a result, the other end of the spring 77 is pulled, and thus the energizing force of the spring 77 increases. Therefore, the pressing force for pressing the pressure roller 59 in the direction toward the heater 51 increases.

In addition, a predetermined load is generated when the fixing belt 57 is rotated around the heating roller 53 and the presser 55. In particular, the load increases as the number of times the fixing device 50 is used increases. For example, the sliding load increases due to a gradual accumulation of abrasion powder on the inner surface of the fixing belt 57.

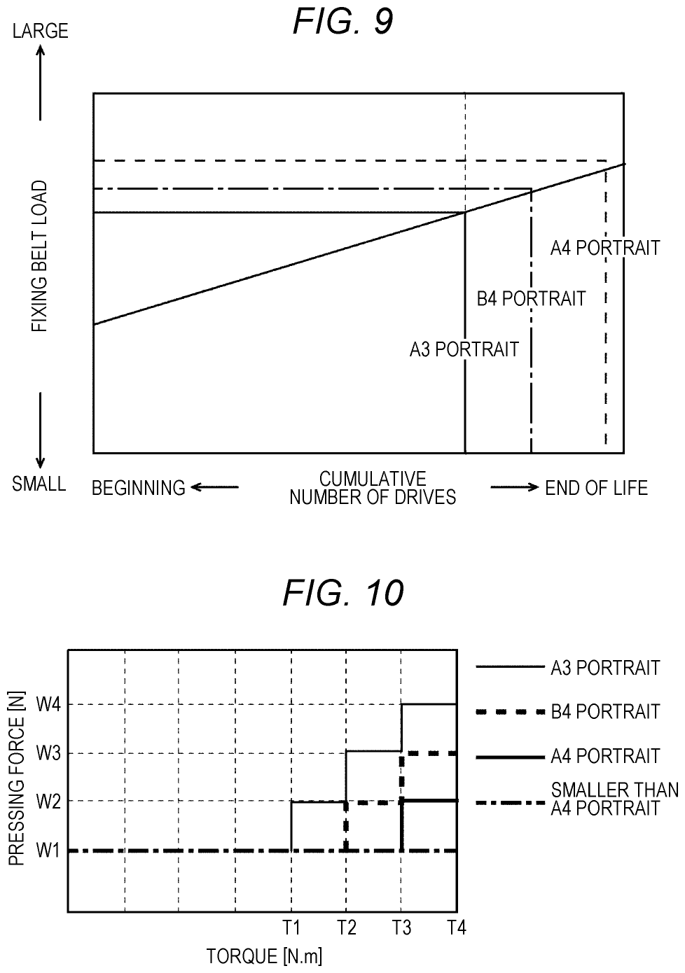

FIG. 9 is a diagram illustrating an example of the relationship between the cumulative number of drives and the load of the fixing belt. The cumulative number of drives is the cumulative value of the number of times paper has passed through the fixing device 50 since the setting of the printer 100. The load of the fixing belt is a load generated when the fixing belt 57 is rotated. Referring to FIG. 9, the cumulative number of drives is proportional to the load of the fixing belt: the larger the cumulative number of drives, the larger the load of the fixing belt.

As described above, assuming that the pressing force with which the pressure roller 59 presses the heater 51 is constant, the longer the length of the paper in the direction across the fixing device 50, the smaller the rotational force transmitted from the pressure roller 59 to the fixing belt 57. FIG. 9 shows, for each size of paper, the load of the fixing belt and the cumulative number of drives at which the pressure roller 59 and the fixing belt 57 start sliding. It is evident from the figure that, assuming that the pressing force with which the pressure roller 59 presses the heater 51 is constant, the load of the fixing belt and the cumulative number of drives at which the pressure roller 59 and the fixing belt 57 start sliding increase in the order of A3 portrait<B4 portrait<A4 portrait (size of paper).

FIG. 10 is a diagram illustrating an example of the relationship between the torque for rotating the pressure roller 59 and the pressing force. The pressing force is the force with which the pressure roller 59 presses the heater 51. FIG. 10 shows an example of the pressing force set for each size of paper with respect to the torque for rotating the pressure roller 59.

The relationship between the torque for rotating the pressure roller 59 and the pressing force in FIG. 10 indicates a sufficient relationship for keeping the pressure roller 59 and the fixing belt 57 from slipping. Note that T1<T2<T3<T4 and W1<W2<W3<W4 are satisfied.

Specifically, in a case where the size of paper is smaller than A4 portrait, the pressing force is set to W1 regardless of torque. In a case where the size of paper is A4 portrait, the pressing force is set to W1 at a torque of up to T3, and the pressing force is set to W2 at a torque of T3 or more. In a case where the size of paper is B4 portrait, the pressing force is set to W1 at a torque of up to T2, the pressing force is set to W2 at a torque of T2 to T3, and the pressing force is set to W3 at a torque of T3 or more. In a case where the size of paper is A3 portrait, the pressing force is set to W1 at a torque of up to T1, the pressing force is set to W2 at a torque of T1 to T2, the pressing force is set to W3 at a torque of T2 to T3, and the pressing force is set to W4 at a torque of T3 or more.

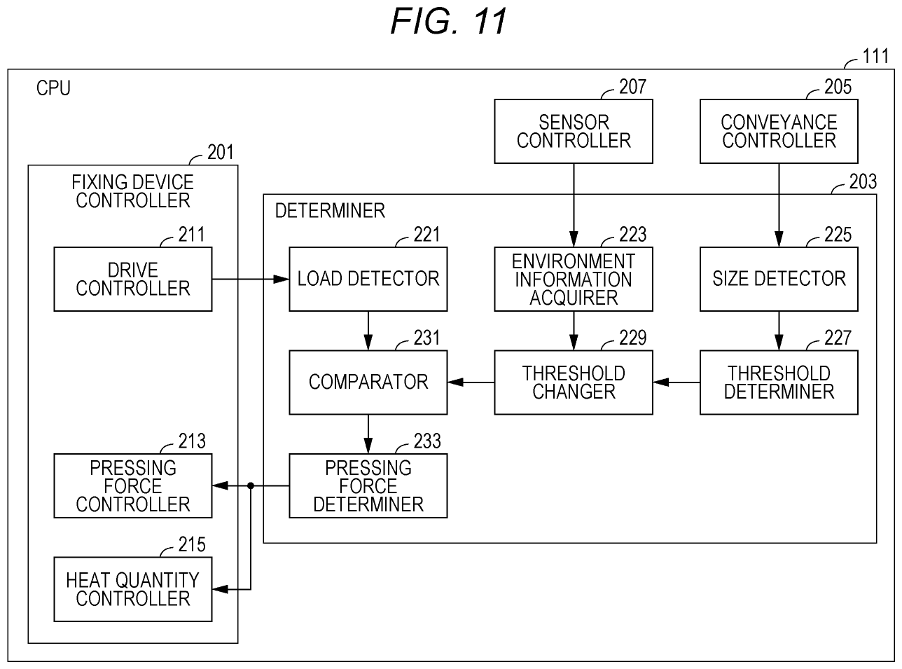

FIG. 11 is a block diagram illustrating an example of the functions of the CPU provided in the printer according to the present embodiment. The functions illustrated in FIG. 11 are implemented by the CPU 111 provided in the printer 100 when the CPU 111 executes the pressing force control program stored in the ROM 113, the HDD 115, or the CD-ROM 118. Referring to FIG. 11, the CPU 111 provided in the printer 100 includes a fixing device controller 201 that controls the fixing device 50, a determiner 203 that determines the pressing force, a sensor controller 207 that controls the sensors installed in the printer 100, and a conveyance controller 205 that controls the paper feeder 150.

The fixing device controller 201 includes a drive controller 211, a pressing force controller 213, and a heat quantity controller 215. The determiner 203 includes a load detector 221, an environment information acquirer 223, a size detector 225, a threshold determiner 227, a threshold changer 229, a comparator 231, and a pressing force determiner 233.

The drive controller 211 controls the drive motor 59B and drives the drive motor 59B. Specifically, the drive controller 211 drives the drive motor 59B such that the pressure roller 59 rotates at a constant speed. In the present embodiment, the drive controller 211 performs current control of the drive motor 59B. The drive controller 211 outputs the value of the current flowing through the drive motor 59B to the load detector 221.

The load detector 221 detects the load of the fixing belt 57 based on the current flowing through the drive motor 59B that rotates the pressure roller 59. The load of the fixing belt 57 is the load of the fixing belt 57 that rotates at a constant speed. When the fixing belt 57 and the pressure roller 59 do not slip, the load of the fixing belt 57 can be regarded as the same as the torque for rotating the pressure roller 59 at a constant speed. The load detector 221 identifies the torque for rotating the pressure roller 59 at a constant speed as the load of the fixing belt 57. The value of the current flowing through the drive motor 59B has a predetermined relationship with the torque for rotating the pressure roller 59 at a constant speed. Using the relationship between current values and torque obtained in advance through an experiment or the like, the load detector 221 detects the torque for rotating the pressure roller 59 at a constant speed from the current value input from the drive controller 211. The load detector 221 outputs the torque for rotating the pressure roller 59 at a constant speed to the comparator 231.

The sensor controller 207 controls the temperature sensor and the humidity sensor installed inside the paper feed cassette 35, and outputs the output of the temperature sensor and the humidity sensor to the environment information acquirer 223. Note that the temperature sensor and the humidity sensor may be set outside the paper feed cassette 35.

The environment information acquirer 223 acquires environment information indicating the environment of the printer 100, and outputs the environment information to the threshold changer 229. The environment information is temperature and humidity. The environment information acquirer 223 outputs, to the threshold changer 229 as the environment information, the output of the temperature sensor and the output of the humidity sensor input from the sensor controller 207.

The conveyance controller 205 controls the paper feeder 150, and conveys the paper contained in the paper feed cassette 35. The conveyance controller 205 outputs, to the size detector 225, information about the paper conveyed. Information about paper includes paper type and paper orientation. Paper type indicates the type of paper such as A3, B4, or A4. Paper orientation indicates the direction in which the paper is conveyed. The direction in which the paper is conveyed can be “portrait”, in which the conveyance direction of the paper and the longitudinal direction of the paper are parallel, or “landscape”, in which the conveyance direction of the paper and the lateral direction of the paper are parallel.

The size detector 225 detects the size of paper. The size of paper is the length, in the direction parallel to the rotation shaft of the pressure roller 59, of the paper that crosses the fixing device 50. The size detector 225 determines the size of paper based on the paper type and paper orientation input from the conveyance controller 205. The size detector 225 outputs the size of paper to the threshold determiner 227.

The threshold determiner 227 determines a threshold based on the size of paper. The threshold determiner 227 determines a threshold using the relationship between the torque for rotating the pressure roller 59 and the pressing force illustrated in FIG. 10. Specifically, in a case where the size of paper is A4 portrait, the torque T3 is set as the threshold with respect to the pressing force W2. In a case where the size of paper is B4 portrait, the torque T2 is set as the threshold with respect to the pressing force W2, and the torque T3 is set as the threshold with respect to the pressing force W3. In a case where the size of paper is A3 portrait, the torque T1 is set as the threshold with respect to the pressing force W2, the torque T2 is set as the threshold with respect to the pressing force W3, and the torque T3 is set as the threshold with respect to the pressing force W4. In a case where the size of paper is smaller than A4 portrait, no threshold is set. The threshold determiner 227 outputs the determined threshold to the threshold changer 229.

The threshold changer 229 receives input of the threshold from the threshold determiner 227 and input of the environment information from the environment information acquirer 223. The environment information is temperature and humidity. Regarding the paper that crosses the fixing device 50, it is empirically known that when the paper passes through the nip part N, moisture in the paper comes out to the surface at the nip part N and causes a reduction in the frictional force between the paper and the pressure roller 59 and/or the frictional force between the paper and the fixing belt 57. Therefore, the threshold changer 229 changes the threshold based on the moisture content in the paper.

Specifically, the threshold changer 229 determines the absolute humidity from the temperature and humidity, and predicts the moisture content from the absolute humidity and the period of time for which the paper is contained in the paper feed cassette 35. As the period of time for which the paper is contained, the threshold changer 229 identifies the elapsed time from the closing of the paper feed cassette 35 based on the sensor output that detects the opening and closing of the paper feed cassette 35. The threshold determined by the threshold determiner 227 is a value set with respect to the reference moisture content. The threshold changer 229 changes the threshold based on the ratio of the determined moisture content and the reference moisture content. The threshold changer 229 changes the threshold to a larger value when the determined moisture content is larger than the reference moisture content, and changes the threshold to a smaller value when the determined moisture content is smaller than the reference moisture content. The relationship between the moisture content and the threshold is preliminarily obtained through an experiment or the like, and the threshold is changed based on the relationship. The relationship between the moisture content and the threshold may be determined using a table or an arithmetic expression.

Note that the moisture content in the paper can be detected by a sensor. For example, a roller for moisture content detection can be placed at a position upstream of the fixing device 50 on the conveyance path for paper, in which case the moisture content in the paper can be measured by detecting the current flowing through the roller for moisture content detection. In this case, instead of the temperature sensor and the humidity sensor, a sensor that detects the current flowing through the roller for moisture content detection may be provided.

The comparator 231 receives input of the torque of the pressure roller 59 from the load detector 221 and input of the threshold from the threshold changer 229. The comparator 231 compares the torque of the pressure roller 59 with the threshold, and outputs the comparison result to the pressing force determiner 233.

The pressing force determiner 233 determines the pressing force based on the comparison result. The pressing force determiner 233 outputs the determined pressing force to the pressing force controller 213 and the heat quantity controller 215. Specifically, in a case where the size of paper is A4 portrait, the pressing force determiner 233 selects the pressing force W1 in response to confirming from the comparison result that the torque of the pressure roller 59 is smaller than the threshold T3 with respect to the pressing force W2, and selects the pressing force W2 in response to confirming that the torque of the pressure roller 59 is larger than or equal to the threshold T3. In a case where the size of paper is B4 portrait, the pressing force determiner 233 selects the pressing force W1 in response to confirming from the comparison result that the torque of the pressure roller 59 is smaller than the threshold T2 with respect to the pressing force W2, selects the pressing force W2 in response to confirming that the torque of the pressure roller 59 is between the threshold T2 (inclusive) and the threshold T3 (exclusive) with respect to the pressing force W3, and selects the pressing force W3 in response to confirming that the torque of the pressure roller 59 is larger than or equal to the threshold T3. In a case where the size of paper is A3 portrait, the pressing force determiner 233 selects the pressing force W1 in response to confirming from the comparison result that the torque of the pressure roller 59 is smaller than the threshold T1 with respect to the pressing force W2, selects the pressing force W2 in response to confirming that the torque of the pressure roller 59 is between the threshold T1 (inclusive) and the threshold T2 (exclusive) with respect to the pressing force W3, selects the pressing force W3 in response to confirming that the torque of the pressure roller 59 is between the threshold T2 (inclusive) and the threshold T3 (exclusive) with respect to the pressing force W4, and selects the pressing force W4 in response to confirming that the torque of the pressure roller 59 is larger than or equal to the threshold T3.

The pressing force controller 213 controls the pressing force adjusting mechanism to adjust the pressing force. Specifically, the variable load gear 75 is rotated such that the pressing force with which the pressure roller 59 presses the fixing belt 57 has the same value as the pressing force input from the pressing force determiner 233.

The heat quantity controller 215 controls the heat source 61 to adjust the temperature of the heating roller 53. The larger the pressing force, the better the performance of fixing the toner in the fibers of the paper at the nip part N. Therefore, the temperature of the fixing belt 57 can be lowered as the pressing force increases. The heat quantity controller 215 controls the heat source 61 such that the heating roller 53 has a predetermined temperature with respect to the pressing force. For example, the temperature of the heating roller 53 is lowered by 3° C. every time the pressing force is increased by 50 N. As a result, electric power consumption in the heat source 61 can be reduced.

By increasing the pressing force and lowering the temperature of the fixing belt 57, it is possible to reduce the discharge of moisture from the inside of the paper while the paper is heated at the nip part N, and it is possible to prevent a decrease in the frictional force between the paper and the fixing belt 57 or the pressure roller 59 at the nip part N. This contributes to preventing the paper from slipping on either the fixing belt 57 or the pressure roller 59, and to preventing the performance of conveying the paper from deteriorating.

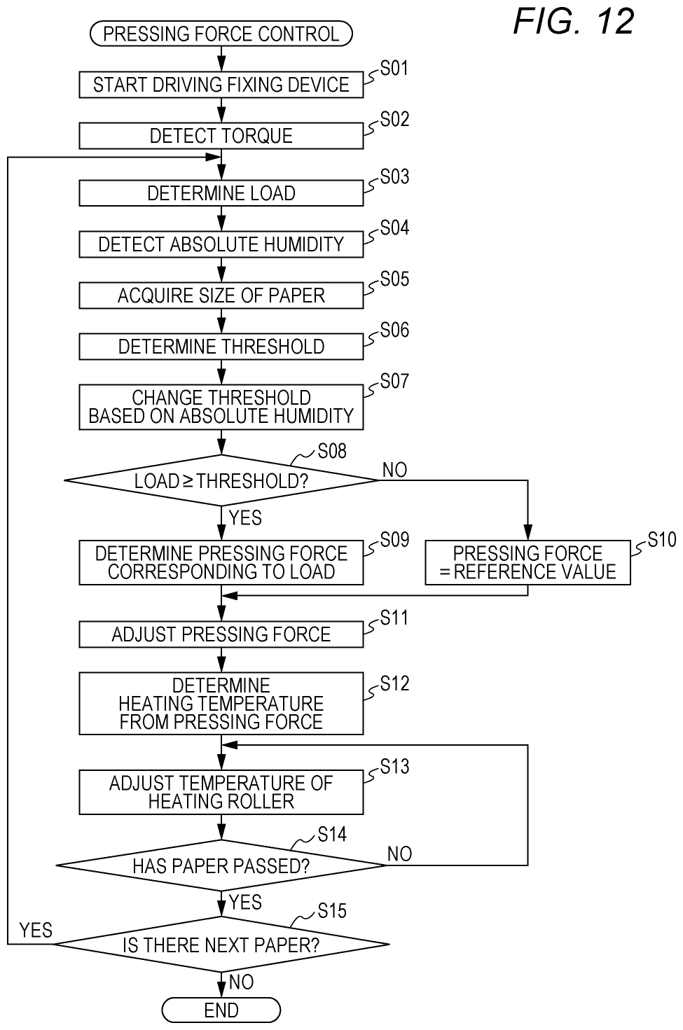

FIG. 12 is a flowchart illustrating an example of the procedure for pressing force control processing. The pressing force control processing is executed by the CPU 111 provided in the printer 100 when the CPU 111 executes the pressing force control program stored in the ROM 113, the HDD 115, or the CD-ROM 118. Referring to FIG. 12, the CPU 111 provided in the printer 100 starts driving the fixing device 50 (step S01). As a result, the drive motor 59B is driven, and heat is provided by the heat source 61. The pressure roller 59 rotates as the drive motor 59B is driven. Further, the fixing belt 57 rotates as the pressure roller 59 rotates. In the next step S02, the torque of the pressure roller 59 is detected. The torque of the pressure roller 59 is detected from the current flowing through the drive motor 59B. Then, the load of the fixing belt 57 is determined (step S03), and the processing proceeds to step S04. There is a predetermined relationship between the torque of the pressure roller 59 and the load of the fixing belt 57. Here, the torque of the pressure roller is identified as the load of the fixing belt 57.

In step S04, the absolute humidity is detected, and the processing proceeds to step S05. The absolute humidity is detected from the temperature and humidity detected by the temperature sensor and the humidity sensor. In step S05, the size of paper is acquired, and the processing proceeds to step S06. The size of the paper on which an image is to be formed is determined. The size of paper is the length, in the direction parallel to the rotation shaft of the pressure roller 59, of the paper that passes through the fixing device 50. The size of paper is determined by paper type and paper orientation.

In step S06, a threshold is determined, and the processing proceeds to step S07. The threshold corresponding to the size of paper is determined. The threshold is determined using the relationship between the torque for rotating the pressure roller 59 and the pressing force illustrated in FIG. 10. Specifically, in a case where the size of paper is A4 portrait, the torque T3 is set as the threshold with respect to the pressing force W2. In a case where the size of paper is B4 portrait, the torque T2 is set as the threshold with respect to the pressing force W2, and the torque T3 is set as the threshold with respect to the pressing force W3. In a case where the size of paper is A3 portrait, the torque T1 is set as the threshold with respect to the pressing force W2, the torque T2 is set as the threshold with respect to the pressing force W3, and the torque T3 is set as the threshold with respect to the pressing force W4. In a case where the size of paper is smaller than A4 portrait, no threshold is set.

In the next step S07, the threshold is changed based on the absolute humidity, and the processing proceeds to step S08. The threshold is changed such that the larger the absolute humidity detected in step S04 is than the reference absolute humidity, the smaller the threshold is, and the smaller the absolute humidity is than the reference absolute humidity, the larger the threshold is. As a result, although moisture in the paper may come out to the surface when the paper passes through the nip part N and cause a reduction in the frictional force between the paper and the fixing belt 57 or the pressure roller 59, it is possible to ensure that the paper is prevented from slipping on the fixing belt 57 or the pressure roller 59.

In step S08, the load of the fixing belt 57 is compared with the threshold. In response to determining that the load of the fixing belt 57 determined in step S03 is larger than or equal to the threshold, the processing proceeds to step S09, otherwise the processing proceeds to step S10. In step S09, the pressing force corresponding to the load of the fixing belt 57 is determined, and the processing proceeds to step S11. Specifically, in a case where the size of paper determined in step S05 is A4 portrait, the threshold T3 with respect to the pressing force W2 is set in step S06. In response to determining that the load of the fixing belt 57, in other words, the load of the pressure roller 59, is larger than or equal to the threshold T3, the processing proceeds to step S09, otherwise the processing proceeds to step S10. In step S09, the pressing force with respect to the load of the pressure roller 59 is determined to be W2. In step S10, the pressing force is determined to be the reference value. The reference value is the pressing force W1.

In a case where the size of paper determined in step S05 is B4 portrait, the threshold T2 with respect to the pressing force W2 and the threshold T3 with respect to the pressing force W3 are set in step S06. In response to determining that the load of the fixing belt 57, in other words, the load of the pressure roller 59, is larger than or equal to the threshold T2, the processing proceeds to step S09, otherwise the processing proceeds to step S10. In step S09, the pressing force is determined to be W2 in response to determining that the load of the pressure roller 59 is smaller than the threshold T3, and the pressing force is determined to be W3 in response to determining that the load of the pressure roller 59 is larger than or equal to the threshold T3. In step S10, the pressing force is determined to be the reference value. The reference value is the pressing force W1.

In a case where the size of paper determined in step S05 is A3 portrait, the threshold T1 with respect to the pressing force W2, the threshold T2 with respect to the pressing force W3, and the threshold T3 with respect to the pressing force W4 are set in step S06. In response to determining that the load of the fixing belt 57, in other words, the load of the pressure roller 59, is larger than or equal to the threshold T1, the processing proceeds to step S09, otherwise the processing proceeds to step S10. In step S09, the pressing force is determined to be W2 in response to determining that the load of the pressure roller 59 is smaller than the threshold T2, the pressing force is determined to be W3 in response to determining that the load of the pressure roller 59 is between the threshold T2 (inclusive) and the threshold T3 (exclusive), and the pressing force is determined to be W4 in response to determining that the load of the pressure roller 59 is larger than or equal to the threshold T3. In step S10, the pressing force is determined to be the reference value. The reference value is the pressing force W1.

Once the pressing force is determined in step S09 or step S10, the processing proceeds to step S11. In step S11, the pressing force is adjusted, and the processing proceeds to step S12. The variable load gear 75 is rotated such that the pressing force with which the pressure roller 59 presses the fixing belt 57 has the same value as the pressing force determined in step S09 or step S10.

In step S12, the heating temperature is determined from the pressing force determined in step S09 or step S10. The heating temperature is the temperature of the heating roller 53. The larger the pressing force, the lower the determined value of the heating temperature. In the next step S13, the temperature of the heating roller 53 is adjusted, and the processing proceeds to step S14. The heat source 61 is controlled such that the heating roller 53 has the heating temperature determined in step S12.

In step S14, it is determined whether the paper has passed through the fixing device 50. In response to determining that the paper has passed through the fixing device 50, the processing proceeds to step S15, otherwise the processing returns to step S13. In step S15, it is determined whether there is the paper to be processed next. In response to determining that there is the paper to be processed, the processing returns to step S03, otherwise the processing ends.

<First Modification>

The pressing force may be determined solely from the size of paper. For example, the pressing force is set to W1 when the size of paper is smaller than A4 portrait, set to W2 when the size of paper is A4 portrait, set to W3 when the size of paper is B4 portrait, and set to W4 when the size of paper is A3 portrait.

<Second Modification>

The threshold may not be changed based on the absolute humidity. In this case, in the block diagram of FIG. 11, the sensor controller 207, the environment information acquirer 223, and the threshold changer 229 are unnecessary. In the comparator 231, the threshold determined by the threshold determiner 227 is compared with the load of the fixing belt 57 detected by the load detector 221.

The present embodiment has described an example in which the pressing force for pressing the pressure roller 59 in the direction toward the heater 51 is adjusted stepwise, but the pressing force may be changed linearly. In this case, although the size of the paper that passes through the fixing device 50 may differ, the pressing force adjusting mechanism enables the pressure roller 59 to transmit a constant level of rotational force to the fixing belt 57.

The pressure roller 59 is pressed against the heater 51 in the present embodiment, but the heater 51 may be pressed against the pressure roller 59.

The load of the fixing belt 57 is obtained from the torque of the pressure roller 59 in the present embodiment, but the load of the fixing belt 57 may be obtained from the number of times the fixing device 50 is driven or the rotation distance of the fixing device 50. As illustrated in FIG. 9, the load of the fixing belt 57 is proportional to the number of times the fixing device 50 is driven. Therefore, by preliminarily obtaining the relationship between the load of the fixing belt 57 and the number of times the fixing device 50 is driven through an experiment or the like, it is possible to obtain the load of the fixing belt 57 from the number of times the fixing device 50 is driven. As the number of times the fixing device 50 is driven, the cumulative value of the rotation frequency of the pressure roller 59 may be used, or the cumulative value of the rotation frequency of the fixing belt 57 may be used. In addition, the comparator 231 may compare the number of drives with the threshold, instead of comparing the load of the fixing belt 57 with the threshold. In this case, the threshold is determined based on a predetermined relationship between the number of times the fixing device 50 is driven and the pressing force.

The present embodiment has described an example in which the pressure roller 59 is pressed against the fixing belt 57, but the pressure roller 59 may be separated from the fixing belt 57 while the fixing device 50 is not driven. Preferably, the pressure roller 59 is pressed against the heater 51 at least while the paper is passing through the nip part N. Consequently, the duration of elastic deformation of the pressure roller can be limited to the period in which the recording medium passes through.

In the present embodiment, the printer 100 has been described as an example of an image forming apparatus, but an image forming apparatus may be a copier, a laser beam printer, a facsimile machine, a multifunction peripheral that is a combination thereof, or the like.

Further, in the present embodiment, the printer 100 of the tandem type that forms a color image has been described as an example of an image forming apparatus. Alternatively, an image forming apparatus that forms a monochrome image may be used. The configurations and arrangements of the image forming units 20Y, 20M, 20C, and 20K, the exposure devices 21Y, 21M, 21C, and 21K, the charge rollers 22Y, 22M, 22C, and 22K, the photoconductor drums 23Y, 23M, 23C, and 23K, the developers 24Y, 24M, 24C, and 24K, the primary transfer rollers 25Y, 25M, 25C, and 25K, the secondary transfer roller 26, and the fixing device 50 are not limited to the present embodiment, and other configurations and arrangements may be used.

It should be considered that the disclosed embodiment is an example in all respects and is not restrictive. The scope of the present invention is defined not by the above description but by the scope of claims, and it is intended that all modifications within the meaning and scope equivalent to the scope of claims are included.

<Appendix>

(1) Preferably, the heating roller has a hollow cylindrical shape, and

a heat source that generates heat is placed inside the heating roller.

According to an embodiment, either the pressure roller or the heater is pressed toward the other with the pressing force determined based on the size of the recording medium that passes through the nip part. Therefore, it is possible to reduce fluctuations in the frictional force between the pressure roller and the heater due to different sizes of recording media. As a result, it is possible to provide an image forming apparatus that prevents deterioration of image quality due to slipping of a recording medium.

According to an embodiment, it is possible to determine the pressing force in accordance with the area of direct contact between the pressure roller and the heater.

According to an embodiment, it is possible to make the frictional force between the pressure roller and the heater larger than the load of rotation of the heater.

According to an embodiment, the pressing force is determined using the threshold set with respect to the size of the recording medium. Therefore, it is possible to make the frictional force between the pressure roller and the heater larger than the load of rotation of the heater in the case of a fluctuation in the area of direct contact between the pressure roller and the heater.

According to an embodiment, because the load of rotation of the heater is obtained from the torque for rotationally driving the pressure roller, it is possible to detect the load of rotation of the heater after the load fluctuates.

According to an embodiment, because the load of rotation of the heater is obtained from the cumulative number of times the pressure roller is rotationally driven, it is possible to detect the load of rotation of the heater even in the case of a fluctuation in the load of rotation of the heater due to wear.

According to an embodiment, it is possible to determine the pressing force in accordance with changes in the environment of the apparatus. For example, because the frictional force between the recording medium and the pressure roller or the heater decreases as the absolute humidity increases, it is possible to determine the pressing force in a manner that depends on the decrease of the frictional force.

According to an embodiment, because the pressure roller is pressed against the heater while the recording medium is passing through the nip part, it is possible to limit the deformation of the pressure roller to the period in which the recording medium passes through.

According to an embodiment, it is possible to reduce the quantity of heat generation as the pressing force increases, and thus to reduce power consumption.

According to an embodiment, it is possible to increase the area of contact between the pressure roller and the fixing belt, and thus to increase the time for pressing and heating the recording medium.

According to an embodiment, it is possible to provide a pressing force control method for preventing deterioration of image quality due to slipping of a recording medium.

According to an embodiment, it is possible to provide a pressing force control program for preventing deterioration of image quality due to slipping of a recording medium.

Although embodiments of the present invention have been described and illustrated in detail, the disclosed embodiments are made for purposes of illustration and example only and not limitation. The scope of the present invention should be interpreted by terms of the appended claims

What is claimed is:

1. An image forming apparatus comprising:
a pressure roller;
a heater that faces the pressure roller and forms a nip part with the pressure roller, the nip part being between the pressure roller and the heater; and
a hardware processor that adjusts a pressing force for pressing either the pressure roller or the heater toward the other and determines the pressing force based on a size of a recording medium that passes through the nip part.

2. The image forming apparatus according to claim 1, wherein
the size of the recording medium is a length, in a direction parallel to a rotation shaft of the pressure roller, of the recording medium that passes through the nip part.

3. The image forming apparatus according to claim 1, wherein
the hardware processor detects a load of rotation of the heater and determines the pressing force when the load is larger than or equal to a predetermined threshold.

4. The image forming apparatus according to claim 3, wherein
the predetermined threshold is set with respect to the size of the recording medium.

5. The image forming apparatus according to claim 3, wherein
the hardware processor rotationally drives the pressure roller, and
detects a torque with which the driver rotationally drives the pressure roller.

6. The image forming apparatus according to claim 3, wherein
the hardware processor rotationally drives the pressure roller and detects a cumulative number of times the driver rotationally drives the pressure roller.

7. The image forming apparatus according to claim 3, wherein
the hardware processor acquires environment information indicating an environment of the image forming apparatus and changes the threshold based further on the environment information.

8. The image forming apparatus according to claim 1, wherein
the hardware processor presses the pressure roller while the recording medium is passing through the nip part.

9. The image forming apparatus according to claim 1, wherein
the hardware processor adjusts a quantity of heat generation at the heater according to the pressing force.

10. The image forming apparatus according to claim 1, wherein
the heater includes:
a fixing belt that is endless;
a heat source that heats the fixing belt; and
a pressing member placed at a position facing the pressure roller inside the fixing belt, and
the fixing belt is pressed between the pressing member and the pressure roller, and slides with respect to the pressing member as the pressure roller rotates.

11. A pressing force control method that is executed on an image forming apparatus, the image forming apparatus comprising:
a pressure roller;
a heater that faces the pressure roller and forms a nip part with the pressure roller, the nip part being between the pressure roller and the heater; and
a hardware processor that adjusts a pressing force for pressing either the pressure roller or the heater toward the other, wherein
the pressing force control method includes:
determining the pressing force based on a size of a recording medium that passes through the nip part; and
controlling the hardware processor such that the hardware processor performs adjustment to apply the pressing force determined.

12. A non-transitory recording medium storing a computer readable pressing force control program that is executed on a computer that controls an image forming apparatus, the image forming apparatus comprising:
a pressure roller;
a heater that faces the pressure roller and forms a nip part with the pressure roller, the nip part being between the pressure roller and the heater; and
a hardware processor that adjusts a pressing force for pressing either the pressure roller or the heater toward the other, wherein
the computer readable pressing force control program causing the computer to execute:
determining the pressing force based on a size of a recording medium that passes through the nip part; and
controlling the hardware processor such that the hardware processor performs adjustment to apply the pressing force determined.
